(19) United States
(12) Patent Application Publication
(10) Pub. No.: US 2011/0088678 A1
(43) Pub. Date: Apr. 21, 2011

(54) METHOD FOR RESUMING OPERATION OF WIRE SAW AND WIRE SAW

(75) Inventor: Koji Kitagawa, Nishishirakawa (JP)

(73) Assignee: SHIN-ETSU HANDOTAI CO., LTD., Tokyo (JP)

(21) Appl. No.: 12/999,844

(22) PCT Filed: Jun. 25, 2009
(86) PCT No.: PCT/JP2009/002910

§ 371 Date: Dec. 17, 2010

(30) Foreign Application Priority Data
Jul. 25, 2008 (JP) 2008-0191855

(51) Int. Cl. B28D 5/04; B24B 1/00

(52) U.S. Cl. 125/16.01; 451/53

(57) ABSTRACT

The present invention is a method for resuming operation of a wire saw comprising the steps of: slicing the workpiece while measuring and recording a displacement amount in an axial direction of each of the grooved rollers and a temperature of the workpiece during the slicing of the workpiece; suspending the slicing of the workpiece; adjusting the displacement amount in an axial direction of each of the grooved rollers and the temperature of the workpiece by supplying temperature-adjusting mediums separately temperature-controlled to the grooved rollers and the workpiece so as to be equal to the displacement amount and temperature recorded upon suspending the slicing of the workpiece respectively, after the suspending, before resuming the slicing of the workpiece; and thereafter resuming the slicing. As a result, there is provided a method for resuming operation of a wire saw and the wire saw that can suppress deterioration of nano-topography of each sliced wafer after processing and can resume to complete the slicing without generation of quality problems of a product wafer, even when the slicing of the workpiece is suspended halfway due to breaking of the wire and the like during the slicing of the workpiece, such as a semiconductor ingot, with the wire saw.

### TECHNICAL FIELD

The present invention relates to a wire saw for slicing a workpiece, such as a semiconductor ingot, by pressing it while a slurry is supplied to a wire, and more particularly to a method for resuming operation of a wire saw when the wire is broken and the wire saw.

### BACKGROUND ART

Conventionally, there has been known a wire saw as a means for slicing a workpiece, such as a semiconductor ingot, into wafers. In the wire saw, a wire for slicing is wound several times around a plurality of grooved rollers so that a wire row is formed, and while the wire for slicing is axially driven at a high speed and a slurry is appropriately supplied, the workpiece is fed against the wire row with it cut into so that the workpiece is sliced at a wire position.

Here, a wire rod having a high abrasion resistance, a high tension resistance, and a high hardness, such as a piano wire, is used for the wire of the wire saw, and a resin roller having a predetermined hardness is used for the grooved rollers to prevent damage of the wire. There are nevertheless instances that slicing into wafers cannot continue because of breaking of the wire during slicing the workpiece due to wear or fatigue of the wire over time.

In this case, conventionally, after extracting operation for extracting the workpiece that is cut into from the wire, pulling operation is carried out, in which the breaking parts of the wire are pulled out appropriately to the outside of one of the grooved rollers by means of pulling the wire by hand or of manual operation of a driving device for the grooved rollers to connect the breaking parts to one another, and thereafter the wire is pulled again so as to locate the connection part of the wire at a position that is not directly involved in slicing the workpiece, or exchanging operation is carried out in which the wire is exchanged for new one if it is unusable.

After such repair operation of the wire, restore operation for engaging each line of the wire with each corresponding part of cutting into the workpiece is carried out, and the slicing of the workpiece is completed by resuming the slicing of the workpiece. In this way, the above-described recovery operation is carried out.

However, except when time required between the start of recovering the wire and the resuming of slicing the workpiece is extremely short, for example, in the event that the wire breaking occurs at a position where the wire is not fit into the grooved rollers, that is, treatment for the wire is merely connecting the wire, in the event that the repair operation of the wire requires a long time (1 hour or more), the grooved rollers thermal-expanded due to heat generated by friction against a bearing parts of the grooved rollers or the wire are cooled and contracted, and the pitch of the wire row narrows in comparison with a condition during the slicing. Therefore, there arises a problem such that when the slicing of the workpiece is resumed in this condition, uncorrectable steps are generated on a sliced face of each sliced wafer.

In view of the above-described problem, there is disclosed an operation restarting method and an apparatus in which passages for introducing a heat exchanging medium into at least the bearing parts of grooved rollers are formed, rotating the grooved rollers and supplying a slurry are stopped when breaking of the wire occurs, the heat exchanging medium is introduced into the passages for the heat exchanging medium to regulate heat contraction, and thereafter recovery operation of the wire is carried out (See Patent Literature 1).

According to the method and the apparatus as above, it is alleged that the wafer steps due to a change in the wire pitch caused by the contraction of the grooved rollers after suspending the slicing can be reduced to within one fourth, even though the repair operation of the wire requires a long time.

### CITATION LIST

Patent Literature 1: Japanese Unexamined Patent publication (Kokai) No. H10-202497

### DISCLOSURE OF INVENTION

However, as quality demand for semiconductor wafers grows with miniaturization of semiconductor devices in recent years, a method for inspecting a wafer becomes highly sensitive, it has become possible to detect fine steps, which are undetectable by step measurement just after slicing with the wire saw, by nano-topography measurement after processing the wafer.

The fine steps as above cannot be completely avoided by the above-described conventional method. Further quality improvement has been therefore required.

The present invention was accomplished in view of the above-explained problems, and its object is to provide a method for resuming operation of a wire saw and the wire saw that can suppress deterioration of nano-topography of each wafer after processing and can resume to complete slicing without generation of quality problems of a product wafer, even when the slicing of the workpiece is suspended halfway due to breaking of the wire and the like during the slicing of the workpiece, such as a semiconductor ingot, with the wire saw.

To achieve this object, the present invention provides a method for resuming operation of a wire saw, including suspending slicing of a workpiece halfway and resuming the slicing, the operation in which a wire wounded between a plurality of grooved rollers is caused to axially travel in a reciprocating direction; a slurry for slicing is supplied to the wire; and the workpiece is pressed against the wire traveling in a reciprocating direction and is fed with the workpiece cut into, by relatively pushing down the workpiece, so that the workpiece is sliced into wafers, the method comprising the steps of: slicing the workpiece while measuring and recording a displacement amount in an axial direction of each of the grooved rollers and a temperature of the workpiece during the slicing of the workpiece; suspending the slicing of the workpiece; adjusting the displacement amount in an axial direction of each of the grooved rollers and the temperature of the workpiece by supplying temperature-adjusting mediums separately temperature-controlled to the grooved rollers and the workpiece so as to be equal to the displacement amount and temperature recorded upon suspending the slicing of the workpiece respectively, after the suspending, before resuming the slicing of the workpiece; and thereafter resuming the slicing.

In this manner, when the method comprises the steps of: slicing the workpiece while measuring and recording a displacement amount in an axial direction of each of the grooved rollers and a temperature of the workpiece during the slicing of the workpiece; suspending the slicing of the workpiece; adjusting the displacement amount in an axial direction of each of the grooved rollers and the temperature of the workpiece by supplying temperature-adjusting mediums separately temperature-controlled to the grooved rollers and the workpiece so as to be equal to the displacement amount and temperature recorded upon suspending the slicing of the workpiece respectively, after the suspending, before resuming the slicing of the workpiece; and thereafter resuming the slicing, thermal expansion conditions of the grooved rollers and the workpiece do not become discontinuous between before suspending the slicing and after resuming it, and the slicing of the workpiece can be completed with suppressing generation of steps on a surface of each sliced wafer and deterioration of the nano-topography.

In this case, the slurry used in the slicing of the workpiece is preferably used as the temperature-adjusting mediums supplied to the grooved rollers and the workpiece.

In this manner, when the slurry used in the slicing of the workpiece is used as the temperature-adjusting mediums supplied to the grooved rollers and the workpiece, it can be readily carried out, the slicing of the workpiece can be rapidly resumed after adjusting the displacement amount in an axial direction of each of the grooved rollers and the temperature of the workpiece, and the generation of steps on the surface of each sliced wafer and the deterioration of the nano-topography can be more effectively suppressed.

In this case, the slurry used in the slicing of the workpiece is preferably used as the temperature-adjusting medium supplied to the grooved rollers, and a gas is preferably used as the temperature-adjusting medium supplied to the workpiece.

In this manner, when the slurry used in the slicing of the workpiece is used as the temperature-adjusting medium supplied to the grooved rollers, and a gas is used as the temperature-adjusting medium supplied to the workpiece, the temperatures can be adjusted with a simpler and more convenient apparatus without adding a new slurry supply circuit for the workpiece, and also the slicing of the workpiece can be rapidly resumed after adjusting the displacement amount in an axial direction of each of the grooved rollers and the temperature of the workpiece, and the generation of steps on the surface of each sliced wafer and the deterioration of the nano-topography can be more effectively suppressed.

Furthermore, the present invention provides a wire saw in which a wire wounded between a plurality of grooved rollers is caused to axially travel in a reciprocating direction; a slurry for slicing is supplied to the wire; and a workpiece is pressed against the wire traveling in a reciprocating direction and is fed with the workpiece cut into, by relatively pushing down the workpiece, so that the workpiece is sliced into wafers, the wire saw comprising: a means for measuring and recording a displacement amount in an axial direction of each of the grooved rollers during the slicing of the workpiece; a means for measuring and recording a temperature of the workpiece during the slicing; and a means for supplying temperature-adjusting mediums separately temperature-controlled to the grooved rollers and the workpiece, wherein the workpiece is sliced while measuring and recording the displacement amount in an axial direction of each of the grooved rollers and the temperature of the workpiece by the recording means for recording the displacement amount and the recording means for recording the temperature; the displacement amount in an axial direction of each of the grooved rollers and the temperature of the workpiece are adjusted by supplying the mediums to the grooved rollers and the workpiece by the supplying means for supplying temperature-adjusting mediums so as to be equal to the displacement amount and temperature recorded upon suspending the slicing of the workpiece respectively, after the slicing of the workpiece is suspended, before the slicing is resumed; and thereafter the slicing is resumed.

In this manner, when the workpiece is sliced while measuring and recording the displacement amount in an axial direction of each of the grooved rollers and the temperature of the workpiece by the recording means for recording the displacement amount and the recording means for recording the temperature; the displacement amount in an axial direction of each of the grooved rollers and the temperature of the workpiece are adjusted by supplying the mediums to the grooved rollers and the workpiece by the supplying means for supplying temperature-adjusting mediums so as to be equal to the displacement amount and temperature recorded upon suspending the slicing of the workpiece respectively, after the slicing of the workpiece is suspended, before the slicing is resumed; and thereafter the slicing is resumed, the wire saw can prevent thermal expansion conditions of the grooved rollers and the workpiece from being discontinuous between before suspending the slicing and after resuming it, and can complete the slicing of the workpiece with suppressing generation of steps on a surface of each sliced wafer and deterioration of the nano-topography.

In this case, the temperature-adjusting mediums supplied to the grooved rollers and the workpiece are preferably the slurry used in the slicing of the workpiece.

In this manner, when the temperature-adjusting mediums supplied to the grooved rollers and the workpiece are the slurry used in the slicing of the workpiece, the wire saw can be readily configured, can rapidly resume the slicing of the workpiece after adjusting the displacement amount in an axial direction of each of the grooved rollers and the temperature of the workpiece, and can more effectively suppress the generation of steps on the surface of each sliced wafer and the deterioration of the nano-topography.

In this case, it is preferable that the temperature-adjusting medium supplied to the grooved rollers is the slurry used in the slicing of the workpiece and that the temperature-adjusting medium supplied to the workpiece is a gas.

In this manner, when the temperature-adjusting medium supplied to the grooved rollers is the slurry used in the slicing of the workpiece and the temperature-adjusting medium supplied to the workpiece is a gas, the wire saw does not need the addition of a new slurry supply circuit for the workpiece, and thus can be more simply and conveniently configured. In addition to these, the wire saw can rapidly resume the slicing of the workpiece after adjusting the displacement amount in an axial direction of each of the grooved rollers and the temperature of the workpiece, and can more effectively suppress the generation of steps on the surface of each sliced wafer and the deterioration of the nano-topography.

In the wire saw according to the present invention, the workpiece is sliced while measuring and recording the displacement amount in an axial direction of each of the grooved rollers and the temperature of the workpiece by the means for recording the displacement amount and the means for recording the temperature; the displacement amount in an axial direction of each of the grooved rollers and the temperature of the workpiece are adjusted by supplying the temperature-adjusting mediums to the grooved rollers and the workpiece by the supplying means for supplying temperature-adjusting mediums so as to be equal to the displacement amount and temperature recorded upon suspending the slicing of the workpiece respectively, after the slicing of the workpiece is suspended halfway, before the slicing is resumed; and thereafter the slicing is resumed. Thermal expansion conditions of the grooved rollers and the workpiece do not therefore become discontinuous between before suspending the slicing and after resuming it, and the wire saw can complete the slicing of the workpiece with suppressing the generation of steps on the surface of each sliced wafer and the deterioration of the nano-topography.

### BRIEF DESCRIPTION OF THE DRAWINGS

FIG. 1 is a schematic view showing an example of the wire saw according to the present invention;

FIG. 2 is a schematic view showing an another example of the wire saw according to the present invention;

FIG. 3 is a flow chart of the method for resuming operation of a wire saw according to the present invention;

FIG. 4 is a view showing the results of Example 1, Example 2, Comparative Example 1, and Comparative Example 2; and

FIG. 5 is a schematic view showing an example of a conventional wire saw (Comparative Example 1).

### BEST MODE FOR CARRYING OUT THE INVENTION

Hereinafter, an embodiment of the present invention will be explained, but the present invention is not restricted thereto.

Conventionally, in slicing of a workpiece, such as a semiconductor, wafer with a wire saw, in the event that the slicing of the workpiece is suspended halfway, for example, due to breaking of the wire and that the slicing is resumed after the recovery operation, taking a long time (1 hour or more) to resume the slicing results in cooling and constricting the workpiece and the grooved rollers that are thermal-expanded due to heat generated by friction against a bearing parts of the grooved rollers or the wire, and the pitch of the wire row narrows in comparison with a condition during the slicing. Therefore, there arises a problem such that when the slicing of the workpiece is resumed in this condition, uncorrectable steps are generated on the sliced face of each sliced wafer.

The steps as above can reduce to a certain degree by a conventional method, but the generation of fine steps detected by nano-topography measurement after processing the wafer cannot be completely avoided. Further quality improvement of the sliced wafer has been therefore required.

In view of this, the present inventor repeatedly keenly conducted studies to solve the above-described problems. As a result, the present inventor conceived that the conditions can be nearer to that before the wire breaking by making the displacement amount of each of the grooved rollers the same as that before suspending the slicing, and in addition, by making a thermal expansion condition of an ingot the same as that before the suspending, and that the nano-topography of each sliced wafer can be consequently improved, and thereby brought the present invention to completion.

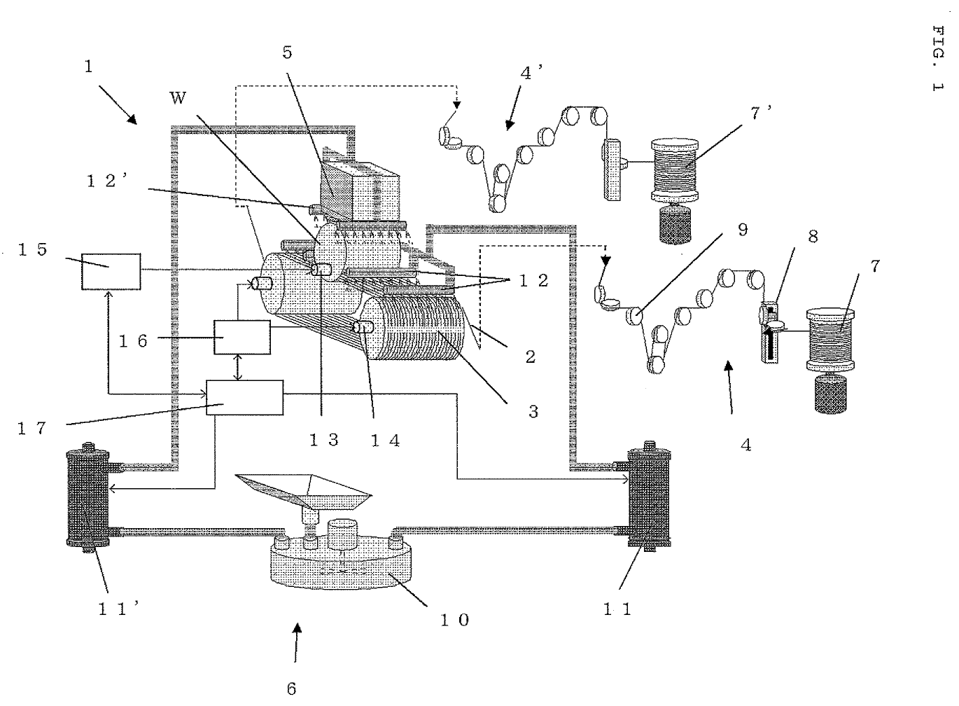

FIG. 1 is a schematic view showing an example of the wire saw according to the present invention.

As shown in FIG. 1, the wire saw 1 according to the present invention mainly comprises the wire 2 for slicing the workpiece W, the grooved rollers 3 around which the wire 2 is wound, a wire-tension-giving mechanism 4 for giving tension to the wire 2, a workpiece-feeding mechanism 5 for feeding the workpiece W to be sliced relatively downward, a slurry tank 10 for supplying a slurry to the wire 2 during slicing, slurry chillers 11, nozzles 12 and the like.

The wire 2 is unreeled from one wire reel 7 and reaches the grooved rollers 3 via the wire-tension-giving mechanism 4 composed of a powder clutch (a constant torque motor 9), a dancer roller (a dead weight) (not shown) and the like through a traverser 8. The wire 2 is wound around this grooved rollers 3 for approximately 300 to 400 turns to form the wire row, and then taken up by a wire reel 7′ via the other wire-tension-giving mechanism 4′.

The wire-tension-giving mechanism 4 can give appropriate tension to the wire 2 during slicing of the workpiece.

The workpiece W is adhered to a pad plate and held with the workpiece-feeding mechanism 5 through the pad plate and a workpiece plate holing the pad plate. The workpiece-feeding mechanism 5 enables feeding the held workpiece W at a previously programmed feed speed by computer control.

Moreover, the wire saw is provided with the recording means 15 for a workpiece temperature that measures and records the temperature of the workpiece W during the slicing. This recording means 15 has a thermometer 13 for measuring the temperature of the workpiece W during the slicing. Here, for example, a radiation thermometer can be used as the thermometer 13. As described above, when the temperature of the workpiece W is measured by using the radiation thermometer, it can be preferably measured at high precision without contact.

The workpiece W is relatively fed to the wire 2 that is located below with the workpiece-feeding mechanism 5 at the time of slicing the workpiece W. The workpiece-feeding mechanism 5 presses the workpiece W against the wire 2 and feeds with the workpiece cut into by relatively pushing down the workpiece W until the wire 2 reaches the pad plate. Then, the sliced workpiece W is extracted from the wire row by reversing the direction of feeding the workpiece W after the slicing of the workpiece W is completed.

Each of the grooved rollers 3 is a roller in which a polyurethane resin is pressed in the periphery of a steel cylinder and grooves are formed at a fixed pitch on a surface thereof. The wound wire 2 can be driven in a reciprocating direction by a driving motor (not shown).

Moreover, as shown in FIG. 1, the wire saw 1 is provided with the recording means 16 for a displacement amount that measures and records the displacement amount in an axial direction of each of the grooved rollers 3. This recording means 16 has a displacement sensor 14 for measuring the displacement amount in an axial direction of each of the grooved rollers 3. Here, for example, an eddy current displacement sensor can be used as the displacement sensor 14. As described above, when the displacement amount of each of the grooved rollers 3 is measured by using the eddy current displacement sensor, it can be preferably measured at high precision without contact.

The recording means 15 for a workpiece temperature and the recording means 16 for a displacement amount of each of the grooved rollers are connected to a control unit 17. The control unit 17 can read the temperature and the displacement amount that are recorded at a predetermined time by the recording means 15 and 16.

Nozzles 12 are arranged above the wire 2 that is wound around the grooved rollers 3 and that travels axially in a reciprocating direction during the slicing so that the slurry for slicing can be supplied to the wire 2 during the slicing of the workpiece W. The nozzles 12 are connected to the slurry tank 10 through the slurry chillers 11. The slurry to be supplied can be supplied form the nozzles 12 to the grooved rollers 3 (the wire 2) after controlling the supply temperature thereof by the slurry chillers 11.

Here, the type of the slurry used during the slicing is not restricted in particular, a conventional slurry can be used. For example, the slurry composed of GC (silicon carbide) abrasive grains dispersed in a liquid can be used.

Moreover, as shown in FIG. 1, the wire saw 1 is provided with the means 6 for supplying temperature-adjusting mediums separately temperature-controlled to the grooved rollers 3 and the workpiece W.

The wire saw 1 can adjust the displacement amount in an axial direction of each of the grooved rollers 3 and the temperature of the workpiece W by supplying the temperature-controlled mediums to the grooved rollers 3 and the workpiece W by the supplying means 6 for these supplying temperature-adjusting mediums.

The supplying means 6 is connected to the control unit 17. With the control unit 17, the displacement amount in an axial direction of each of the grooved rollers 3 and the temperature of the workpiece W can be controlled so as to be equal to the displacement amount in an axial direction of each of the grooved rollers 3 and the temperature of the workpiece W that are recorded by the recording means 15 and 16 respectively, the recorded displacement amount and temperature which are read by the control unit 17. For example, the displacement amount in an axial direction of each of the grooved rollers 3 and the temperature of the workpiece W can be adjusted by supplying the slurry that is temperature-controlled by means of controlling the slurry chillers 11 and 11′ to the grooved rollers 3 and the workpiece W through the nozzles 12 and 12′.

In the wire saw according to the present invention, the workpiece W is sliced while measuring and recording the displacement amount in an axial direction of each of the grooved rollers 3 and the temperature of the workpiece W at regular intervals by the recording means 15 and 16, the displacement amount in an axial direction of each of the grooved rollers 3 and the temperature of the workpiece W are adjusted by supplying the mediums to the grooved rollers 3 and the workpiece W by the supplying means 6 for supplying temperature-adjusting mediums so as to be equal to the displacement amount and temperature recorded upon suspending the slicing of the workpiece W respectively, after the slicing of the workpiece W is suspended halfway, before the slicing is resumed, and thereafter the slicing is resumed.

The wire saw as above can prevent thermal expansion conditions of the grooved rollers 3 and the workpiece W from being discontinuous between before suspending the slicing and after resuming it, and can complete the slicing of the workpiece with suppressing the generation of steps on the surface of each sliced wafer and the deterioration of the nano-topography.

Here, when the displacement amount of each of the grooved rollers 3 and the temperature of the workpiece W are adjusted so as to be equal to the displacement amount and temperature recorded upon suspending the slicing of the workpiece W respectively, it is preferable that the difference between the adjusted displacement amount and the recorded displacement amount upon suspending is within ±1 μm, and that the difference between the adjusted temperature and the recorded temperature upon suspending is within ±1° C. When they are within a predetermined range as described above, effects of the present invention that are suppression of the generation of steps on the surface of each sliced wafer and the deterioration of the nano-topography are sufficiently achieved.

In this case, as shown in FIG. 1, the temperature-adjusting mediums supplied to the grooved rollers 3 and the workpiece W are preferably the slurry used in the slicing of the workpiece W.

As described above, when the temperature-adjusting mediums supplied to the grooved rollers 3 and the workpiece W are the slurry used in the slicing of the workpiece W, the structure of the wire saw can be simple and convenient since an another temperature-adjusting medium does not need to be prepared, and the wire saw can rapidly resume the slicing of the workpiece W without stopping the slurry supply after adjusting the displacement amount in an axial direction of each of the grooved rollers 3 and the temperature of the workpiece W, and can more effectively suppress the generation of steps on the surface of each sliced wafer and the deterioration of the nano-topography.

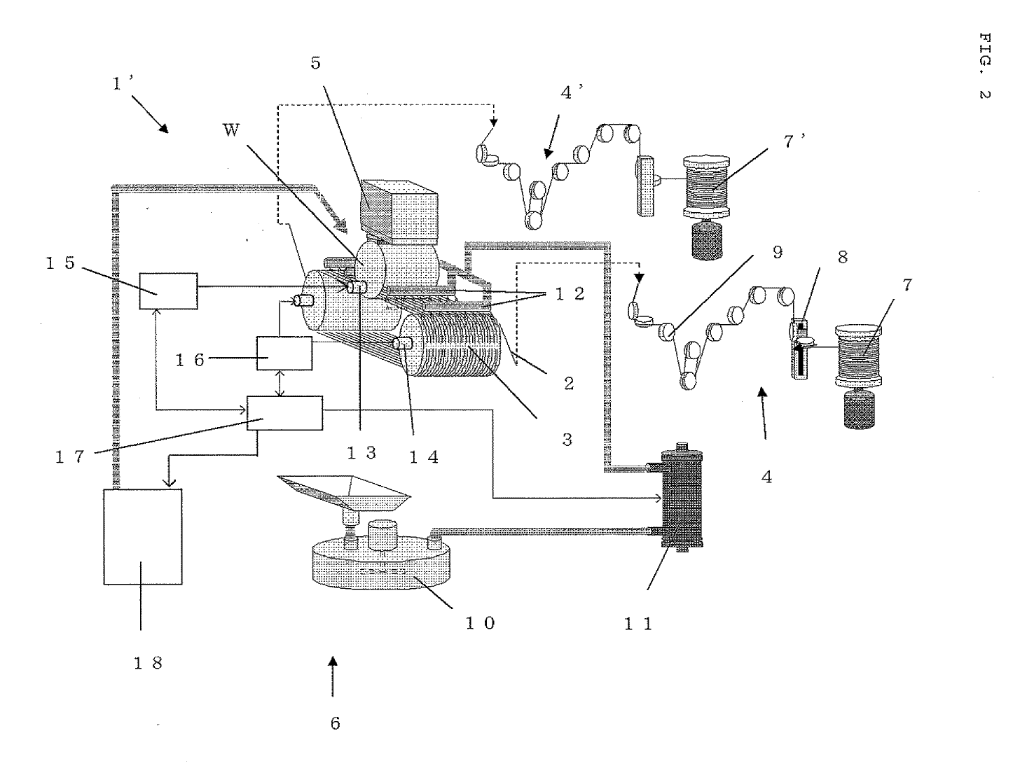

Alternatively, as shown in FIG. 2, it is possible that the temperature-adjusting medium supplied to the grooved rollers 3 is the slurry used in the slicing of the workpiece W and that the wire saw is provided with an apparatus for supplying a temperature-adjusting air 18 for supplying a temperature-controlled air to the workpiece W and the temperature-adjusting medium supplied to the workpiece W is a gas supplied through the apparatus for supplying a temperature-adjusting air 18.

As described above, when the temperature-adjusting medium supplied to the grooved rollers 3 is the slurry used in the slicing of the workpiece W and the temperature-adjusting medium supplied to the workpiece W is a gas, the wire saw does not need the addition of a new slurry supply circuit for the workpiece W, and thus can be a simpler and more convenient apparatus. In addition to these, the wire saw can rapidly resume the slicing of the workpiece W without stopping the slurry supply after adjusting the displacement amount in an axial direction of each of the grooved rollers 3 and the temperature of the workpiece W, and can more effectively suppress the generation of steps on the surface of each sliced wafer and the deterioration of the nano-topography.

Next, the method for resuming operation of a wire saw according to the present invention will be explained.

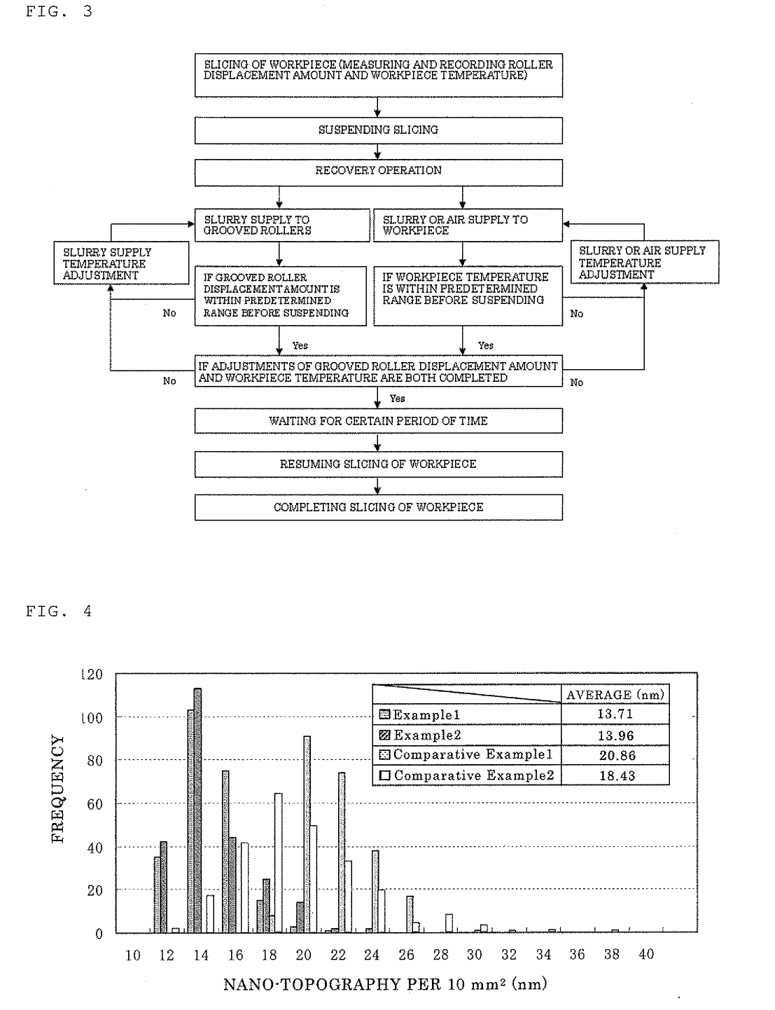

Here, FIG. 3 shows a flow chart of the method for resuming operation of a wire saw according to the present invention.

As a premise, first, the workpiece W is adhered to the pad plate and the pad plate is held with the workpiece plate to slice the workpiece W. Then, the workpiece W is held with the workpiece-feeding mechanism 5 through the pad plate and the workpiece plate.

Next, the wire 2 is given tension and caused to axially travel in a reciprocating direction. While the slurry is supplied to the wire 2, the workpiece W is fed against the wire row with the workpiece cut into, by relatively pushing down the workpiece W held with the workpiece-feeding mechanism 5 so that the workpiece W is sliced.

Here, in the present invention, the displacement amount in an axial direction of each of the grooved rollers 3 and the temperature of the workpiece W are measured and recorded at regular intervals by the recording means 15 and 16 during the slicing of the workpiece W.

Then, the slicing of the workpiece W is suspended, for example, due to an occurrence of breaking of the wire 2. When the slicing is resumed, after suspending the slicing, first the cause for suspending is removed and the recovery operation is carried out. For example, in case of the occurrence of the breaking of the wire 2, repair operation of the wire 2 is carried out, and thereafter the recovery operation is carried out in which each line of the wire row is engaged with each corresponding part of cutting into the workpiece W. After completing the recovery operation, the temperature-adjusting mediums separately temperature-controlled are supplied to the grooved rollers 3 and the workpiece W.

Thereafter, the displacement amount in an axial direction of each of the grooved rollers 3 and the temperature of the workpiece W are controlled to adjust by the control unit 17 so as to be equal to the displacement amount and temperature recorded upon suspending the slicing of the workpiece W respectively.

Here, it is preferably controlled in such a manner that the difference between the adjusted displacement amount and the recorded displacement amount upon suspending is within ±1 μm, and that the difference between the adjusted temperature and the recorded temperature upon suspending is within ±1° C.

After the adjustments of the displacement amount in an axial direction of each of the grooved rollers 3 and the temperature of the workpiece W are both completed as described above, the slicing of the workpiece W is resumed. In this case, the temperature of the workpiece W and the displacement amount of each of the grooved rollers 3 are preferably stabilized by waiting for a certain period of time before resuming the slicing.

As described above, when the method comprises the steps of: slicing the workpiece W while measuring and recording the displacement amount in an axial direction of each of the grooved rollers 3 and the temperature of the workpiece W during the slicing of the workpiece; suspending the slicing of the workpiece W; adjusting the displacement amount in an axial direction of each of the grooved rollers 3 and the temperature of the workpiece W by supplying the temperature-adjusting mediums separately temperature-controlled to the grooved rollers 3 and the workpiece W so as to be equal to the displacement amount and temperature recorded upon suspending the slicing of the workpiece W respectively, after the suspending, before resuming the slicing of the workpiece W; and thereafter resuming the slicing, the thermal expansion conditions of the grooved rollers 3 and the workpiece W do not become discontinuous between before suspending the slicing and after resuming it, and the slicing of the workpiece W can be completed with suppressing the generation of steps on the surface of each sliced wafer and the deterioration of the nano-topography.

In this case, the slurry used in the slicing of the workpiece W is preferably used as the temperature-adjusting mediums supplied to the grooved rollers 3 and the workpiece W.

As described above, when the slurry used in the slicing of the workpiece W is used as the temperature-adjusting mediums supplied to the grooved rollers 3 and the workpiece W, it can be readily carried out since an another medium does not need to be prepared, the slicing of the workpiece W can be rapidly resumed without stopping the slurry supply after adjusting the displacement amount in an axial direction of each of the grooved rollers 3 and the temperature of the workpiece W, and the generation of steps on the surface of each sliced wafer and the deterioration of the nano-topography can be more effectively suppressed.

In this case, the slurry used in the slicing of the workpiece W is preferably used as the temperature-adjusting medium supplied to the grooved rollers 3 and a gas is preferably used as the temperature-adjusting medium supplied to the workpiece W.

As described above, when the slurry used in the slicing of the workpiece W is used as the temperature-adjusting medium supplied to the grooved rollers 3 and a gas is used as the temperature-adjusting medium supplied to the workpiece W, the temperatures can be adjusted with a simpler and more convenient apparatus without adding a new slurry supply circuit for the workpiece W, the slicing of the workpiece W can be rapidly resumed after adjusting the displacement amount in an axial direction of each of the grooved rollers 3 and the temperature of the workpiece W, and the generation of steps on the surface of each sliced wafer and the deterioration of the nano-topography can be more effectively suppressed.

Hereinafter, the present invention will be explained in more detail based on Examples and Comparative Examples, but the present invention is not restricted thereto.

### EXAMPLE 1

The wire saw according to the present invention as shown in FIG. 1 was used to slice a silicon ingot having a diameter of 300 mm and the slicing was suspended halfway. After 1 hour from the suspending, the slicing was resumed based on the method for resuming operation according to the present invention as shown in FIG. 3 to obtain 232 silicon wafers. The sliced wafers obtained as above were subjected to lapping processing and polishing processing, and thereafter the nano-topography was measured and evaluated.

FIG. 4 shows the result of the measured nano-topography. As shown in FIG. 4, an average value of the nano-topography was 13.71 nm, and it was confirmed that the nano-topography was improved in comparison with the results of the later-explained Comparative Examples 1 and 2.

In addition, the failure rate of the nano-topography was 5 to 10% and was able to be suppressed low.

It was thus confirmed that the method for resuming operation of a wire saw and the wire saw according to the present invention enable the slicing of the workpiece to be completed with suppressing the generation of steps on the surface of each sliced wafer and the deterioration of the nano-topography.

### EXAMPLE 2

As with Example 1 except for using the wire saw according to the present invention as shown in FIG. 2, the slicing of a workpiece was suspended and the slicing was resumed, and the same evaluation as Example 1 was carried out.

FIG. 4 shows the result of the measured nano-topography. As shown in FIG. 4, an average value of the nano-topography was 13.96 nm, and it was confirmed that the nano-topography was improved in comparison with the results of the later-explained Comparative Examples 1 and 2.

In addition, the failure rate of the nano-topography was 5 to 10% and was able to be suppressed low.

It was thus confirmed that the method for resuming operation of a wire saw and the wire saw according to the present invention enable the slicing of the workpiece to be completed with suppressing the generation of steps on the surface of each sliced wafer and the deterioration of the nano-topography.

### COMPARATIVE EXAMPLE 1

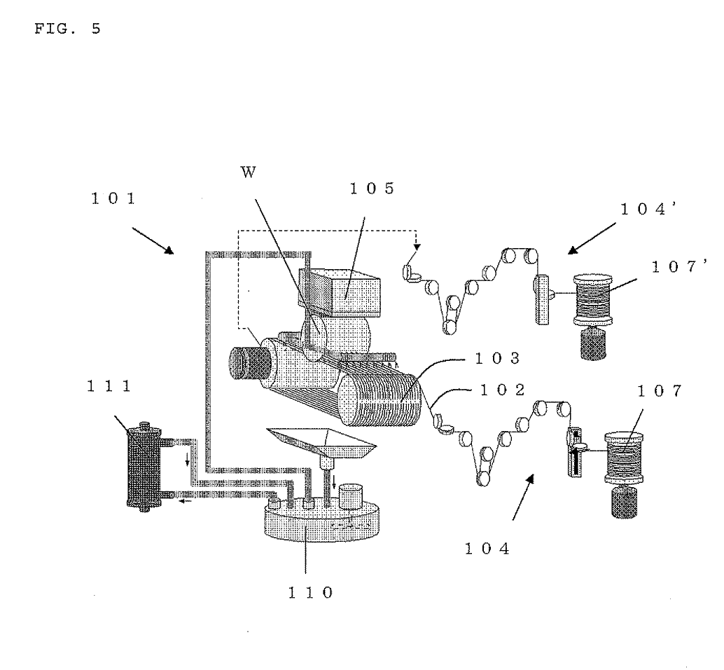

A conventional wire saw as shown in FIG. 5 was used to slice a silicon ingot having a diameter of 300 mm into wafers and the slicing was suspended halfway. Just after 1 hour from the suspending, the slicing was resumed without adjusting the displacement amount of each of the grooved rollers and the temperature of the workpiece, to obtain 231 silicon wafers. The sliced wafers obtained as above were subjected to lapping processing and polishing processing, and thereafter the nano-topography was measured and evaluated.

FIG. 4 shows the result. As shown in FIG. 4, an average value of the nano-topography was 20.86 nm, and it was confirmed that the nano-topography was worse in comparison with the results of Example 1 and 2.

In addition, steps were generated on the surface of each sliced wafer. All of the wafers had nano-topography failure.

### COMPARATIVE EXAMPLE 2

As with Comparative Example 1 except for providing, to a conventional wire saw as shown in FIG. 5, a supply circuit for supplying a slurry to grooved rollers and adjusting the displacement amount of each of the grooved rollers by supplying the slurry before resuming slicing so as to be equal to a condition before suspending without supplying a temperature-adjusting medium to a workpiece, the workpiece was sliced into wafers, and the same evaluation as Comparative Example 1 was carried out.

As a result, as shown in FIG. 4, an average value of the nano-topography was 18.43 nm, and it was confirmed that the nano-topography was worse in comparison with the results of Examples 1 and 2.

In addition, fine steps were generated on the surface of each sliced wafer.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

1. A method for resuming operation of a wire saw, including suspending slicing of a workpiece halfway and resuming the slicing, the operation in which a wire wounded between a plurality of grooved rollers is caused to axially travel in a reciprocating direction; a slurry for slicing is supplied to the wire; and the workpiece is pressed against the wire traveling in a reciprocating direction and is fed with the workpiece cut into, by relatively pushing down the workpiece, so that the workpiece is sliced into wafers, the method comprising the steps of:
slicing the workpiece while measuring and recording a displacement amount in an axial direction of each of the grooved rollers and a temperature of the workpiece during the slicing of the workpiece;
suspending the slicing of the workpiece;
adjusting the displacement amount in an axial direction of each of the grooved rollers and the temperature of the workpiece by supplying temperature-adjusting mediums separately temperature-controlled to the grooved rollers and the workpiece so as to be equal to the displacement amount and temperature recorded upon suspending the slicing of the workpiece respectively, after the suspending, before resuming the slicing of the workpiece; and thereafter
resuming the slicing.

2. The method for resuming operation of a wire saw according to claim 1, wherein the slurry used in the slicing of the workpiece is used as the temperature-adjusting mediums supplied to the grooved rollers and the workpiece.

3. The method for resuming operation of a wire saw according to claim 1, wherein the slurry used in the slicing of the workpiece is used as the temperature-adjusting medium supplied to the grooved rollers, and a gas is used as the temperature-adjusting medium supplied to the workpiece.

4. A wire saw in which a wire wounded between a plurality of grooved rollers is caused to axially travel in a reciprocating direction; a slurry for slicing is supplied to the wire; and a workpiece is pressed against the wire traveling in a reciprocating direction and is fed with the workpiece cut into, by relatively pushing down the workpiece, so that the workpiece is sliced into wafers, the wire saw comprising:
a means for measuring and recording a displacement amount in an axial direction of each of the grooved rollers during the slicing of the workpiece;
a means for measuring and recording a temperature of the workpiece during the slicing; and
a means for supplying temperature-adjusting mediums separately temperature-controlled to the grooved rollers and the workpiece, wherein
the workpiece is sliced while measuring and recording the displacement amount in an axial direction of each of the grooved rollers and the temperature of the workpiece by the recording means for recording the displacement amount and the recording means for recording the temperature;
the displacement amount in an axial direction of each of the grooved rollers and the temperature of the workpiece are adjusted by supplying the mediums to the grooved rollers and the workpiece by the supplying means for supplying temperature-adjusting mediums so as to be equal to the displacement amount and temperature recorded upon suspending the slicing of the workpiece respectively, after the slicing of the workpiece is suspended halfway, before the slicing is resumed; and thereafter
the slicing is resumed.

5. The wire saw according to claim 4, wherein the temperature-adjusting mediums supplied to the grooved rollers and the workpiece are the slurry used in the slicing of the workpiece.

6. The wire saw according to claim 4, wherein the temperature-adjusting medium supplied to the grooved rollers is the slurry used in the slicing of the workpiece and the temperature-adjusting medium supplied to the workpiece is a gas.
